(19) United States
(12) Patent Application Publication
(10) Pub. No.: US 2003/0083442 A1
(43) Pub. Date: May 1, 2003

(54) Molded flame-retardant polycarbonate resin composition

(76) Inventors: Hajime Nishihara, Yokohama-shi (JP); Hiroshi Yamaki, Kawasaki-shi (JP)

Correspondence Address: BIRCH STEWART KOLASCH & BIRCH, PO BOX 747, FALLS CHURCH, VA, 22040-0747, US

(21) Appl. No.: 10/168,089

(22) PCT Filed: Dec. 18, 2000
(86) PCT No.: PCT/JP00/08967

(30) Foreign Application Priority Data
Dec. 17, 1999 (JP) 11/359377

(51) Int. Cl. C08F 8/00

(52) U.S. Cl. 525/464; 525/146

(57) ABSTRACT

Disclosed is a shaped article obtained by (1) melting a flame retardant polycarbonate resin composition comprising a resin component (A) consisting of an aromatic polycarbonate or mainly comprising an aromatic polycarbonate, and a non-halogen flame retardant (B), and (2) molding the resultant molten resin composition, wherein the number of discrete particles, dispersed in said shaped article, each having a size of 50 μm or more, is 0 to 100/mm² as measured with respect to the surface of a flat sample cut out from the shaped article.

### BACKGROUND OF THE INVENTION

1. Field of the Invention

The present invention relates to a shaped article of a flame retardant polycarbonate resin composition. More particularly, the present invention is concerned with a shaped article obtained by (1) melting a flame retardant polycarbonate resin composition comprising a resin component (A) consisting of an aromatic polycarbonate or mainly comprising an aromatic polycarbonate, and a non-halogen flame retardant (B), and (2) molding the resultant molten resin composition, wherein the number of discrete particles, dispersed in the shaped article, each having a size of 50 μm or more, is limited. The shaped article of the present invention exhibits not only an excellent flame retardancy, but also excellent appearance, impact resistance and stability in quality (e.g., ability to suppress lowering of Izod impact strength of the shaped article, which occurs during a continuous molding of the above-mentioned molten resin composition), so that the shaped article of the present invention can be advantageously used in various application fields, such as automobile parts, parts for use in household electric appliances, and parts for office automation machines.

2. Prior Art

An aromatic polycarbonate resin has an excellent moldability and an excellent impact resistance as compared to those of a glass or a metal, so that shaped articles of an aromatic polycarbonate resin have been used in various fields, such as automobile parts, parts for use in household electric appliances, and parts for office automation machines. However, an aromatic polycarbonate resin is easily flammable and, hence, the use of the aromatic polycarbonate resin is limited due to the flammability thereof.

In this situation, for imparting flame retardancy to an aromatic polycarbonate resin, it has been attempted to add a flame retardant to the aromatic polycarbonate resin. Examples of flame retardants include a halogen-containing flame retardant, a phosphorus-containing flame retardant, an inorganic flame retardant, and a silicon-containing flame retardant. Of these flame retardants, a silicon-containing flame retardant is most effective. The objective of imparting flame retardancy to an aromatic polycarbonate resin has been attained to some extent by the use of any of these flame retardants. That is, a shaped article of an aromatic polycarbonate resin composition containing such a flame retardant exhibits a certain level of flame retardancy.

However, by the above-mentioned method, i.e., by addition of a flame retardant to an aromatic polycarbonate resin, it is impossible to improve the flame retardancy of an aromatic polycarbonate resin composition to a level which meets the demand for improved safety in the accident of fire, which has been rapidly increasing in recent years. Further, the use of a halogen-containing flame retardant poses environmental problems, and the use of a phosphorus-containing flame retardant or an inorganic flame retardant is disadvantageous in that a shaped article of an aromatic polycarbonate resin composition containing such a flame retardant has unsatisfactory strength. On the other hand, a shaped article of an aromatic polycarbonate resin composition containing a silicon-containing flame retardant exhibits a high flame retardancy as compared to that of a shaped article of an aromatic polycarbonate resin composition containing a halogen-containing flame retardant, a phosphorus-containing flame retardant or an inorganic flame retardant. However, a silicon-containing flame retardant has poor compatibility with an aromatic polycarbonate, so that the use of a shaped article of an aromatic polycarbonate resin composition containing a silicon-containing flame retardant is inevitably limited.

It is considered that, for a shaped article of an aromatic polycarbonate resin composition containing a flame retardant to exhibit an excellent flame retardancy, the components of the shaped article (especially, the flame retardant and/or derivatives thereof) need to be uniformly dispersed in the shaped article. However, there has not yet been known a specific method for appropriately controlling the dispersion of the components in a shaped article to obtain a shaped article exhibiting an excellent flame retardancy. In conventional methods for producing a shaped article of an aromatic polycarbonate resin composition containing a flame retardant, the dispersion of the components in the shaped article is not appropriately controlled, so that a shaped article having excellent properties, such as an excellent flame retardancy, cannot be obtained.

The non-uniform dispersion of the components in the conventional shaped article occurs due to the high melt viscosity of the aromatic polycarbonate used for producing the conventional shaped article. Specifically, an aromatic polycarbonate has a high melt viscosity and, hence, an aromatic polycarbonate resin composition obtained by adding a flame retardant to an aromatic polycarbonate resin generates a large amount of heat during the molding thereof. The heat generation promotes the decomposition of the flame retardant and/or the aromatic polycarbonate resin. As a result, the dispersion of the components in the shaped article obtained becomes non-uniform and, hence, the shaped article exhibits an unsatisfactory flame retardancy.

A large amount of heat generated during the molding of the aromatic polycarbonate resin composition, as mentioned above, promotes the decomposition of the aromatic polycarbonate resin, so that the strength of the resultant shaped article becomes unsatisfactory.

Conventionally, a method for reducing the melt viscosity of an aromatic polycarbonate resin containing no flame retardant has been known; however, there has not been known a method for reducing the melt viscosity of an aromatic polycarbonate resin composition containing a flame retardant.

For example, WO 98/52734 discloses a method which comprises blowing carbon dioxide into an aromatic polycarbonate resin during the injection molding thereof to thereby lower the melt viscosity of the aromatic polycarbonate resin.

U.S. Pat. No. 4,990,595 discloses a method in which an aromatic polycarbonate resin is melted in the presence of a supercritical gas to thereby lower the shear melt viscosity of the aromatic polycarbonate resin by at least 10%.

However, each of these two patent documents has no description or suggestion about a method for reducing the melt viscosity of an aromatic polycarbonate resin composition containing a flame retardant. Specifically, since there is a great difference in the dispersion of the components between an aromatic polycarbonate resin composition containing no flame retardant and an aromatic polycarbonate resin composition containing a flame retardant, neither of the above-mentioned two patent documents (each disclosing only a method for reducing the melt viscosity of an aromatic polycarbonate resin containing no flame retardant) provides any suggestion about a method for reducing the melt viscosity of an aromatic polycarbonate resin composition containing a flame retardant to thereby obtain an aromatic polycarbonate resin composition which can be used for producing a shaped article exhibiting a uniform dispersion of the components.

Further, neither of the above-mentioned two patent documents has any description about a shaped article of an aromatic polycarbonate resin composition containing a flame retardant. Needless to say, neither of the two patent documents has any suggestion as to a method for appropriately controlling the dispersion of the components in a shaped article to thereby obtain a shaped article having an excellent flame retardancy.

### SUMMARY OF THE INVENTION

In this situation, with respect to a shaped article obtained by melt-molding an aromatic polycarbonate resin composition containing a flame retardant, the present inventors have made extensive and intensive studies with a view toward determining an appropriate dispersion of the components in the shaped article for obtaining a shaped article exhibiting an excellent flame retardancy. The present inventors have also made extensive and intensive studies with a view toward developing a method for producing a shaped article of a flame retardant aromatic polycarbonate resin composition, which has the above-mentioned appropriate dispersion of the components, so that the shaped article exhibits an excellent flame retardancy.

As a result, it has unexpectedly been found that a specific shaped article exhibits not only an excellent flame retardancy, but also excellent appearance, impact resistance and stability in quality. The above-mentioned specific shaped article is a shaped article obtained by a method comprising (1) melting a flame retardant polycarbonate resin composition comprising a resin component (A) consisting of an aromatic polycarbonate or mainly comprising an aromatic polycarbonate, and a non-halogen flame retardant (B), and (2) molding the resultant molten resin composition, wherein the number of discrete particles, dispersed in the shaped article, each having a size of 50 μm or more, is 0 to 100/mm² as measured with respect to the surface of a flat sample cut out from the shaped article. Further, it has also been found that the above-mentioned shaped article can be effectively produced when, in the above-mentioned method, the molten flame retardant polycarbonat resin composition which is being molded has carbon dioxide dissolved therein, so that the molten resin composition having carbon dioxide dissolved therein exhibits a shear melt viscosity which is lower than the shear melt viscosity exhibited by the resin composition having no carbon dioxide dissolved therein. Based on these findings, the present invention has been completed.

Accordingly, it is a primary object of the present invention to provide a shaped article in which the dispersion of the components thereof is desirably controlled and which exhibits not only an excellent flame retardancy, but also excellent appearance, impact resistance and stability in quality.

The foregoing and other objects, features and advantages of the present invention will be apparent from the following detailed description and appended claims.

### DETAILED DESCRIPTION OF THE INVENTION

According to the present invention, there is provided a shaped article obtained by (1) melting a flame retardant polycarbonate resin composition comprising a resin component (A) consisting of an aromatic polycarbonate or mainly comprising an aromatic polycarbonate, and a non-halogen flame retardant (B), and (2) molding the resultant molten resin composition, wherein the number of discrete particles, dispersed in the shaped article, each having a size of 50 μm or more, is 0 to 100/mm² as measured with respect to the surface of a flat sample cut out from the shaped article.

For easy understanding of the present invention, the essential features and various preferred embodiments of the present invention are enumerated below.

1. A shaped article obtained by (1) melting a flame retardant polycarbonate resin composition comprising a resin component (A) consisting of an aromatic polycarbonate or mainly comprising an aromatic polycarbonate, and a non-halogen flame retardant (B), and (2) molding the resultant molten resin composition, wherein the number of discrete particles, dispersed in the shaped article, each having a size of 50 μm or more, is 0 to 100/mm² as measured with respect to the surface of a flat sample cut out from the shaped article.

2. The shaped article according to item 1 above, wherein the molten flame retardant polycarbonate resin composition which is being molded has carbon dioxide dissolved therein, so that the molten resin composition having carbon dioxide dissolved therein exhibits a shear melt viscosity which is lower than the shear melt viscosity exhibited by the resin composition having no carbon dioxide dissolved therein.

3. The shaped article according to item 2 above, wherein the molten resin composition having carbon dioxide dissolved therein exhibits a shear melt viscosity which is lowered by 10% or more, relative to the shear melt viscosity exhibited by the resin composition having no carbon dioxide dissolved therein.

4. The shaped article according to item 2 or 3 above, wherein the molten resin composition having carbon dioxide dissolved therein is subjected to injection molding, wherein the molten resin composition having carbon dioxide dissolved therein is injected into a mold cavity which has been pressurized by carbon dioxide gas to a pressure level wherein no foaming occurs at a flow front of the molten resin composition in the cavity.

5. The shaped article according to any one of items 1 to 4 above, wherein the non-halogen flame retardant is at least one flame retardant selected from the group consisting of an organic flame retardant and an inorganic flame retardant.

6. The shaped article according to item 5 above, wherein the organic flame retardant is at least one flame retardant selected from the group consisting of a silicon-containing flame retardant, a sulfur-containing flame retardant and a phosphorus-containing flame retardant.

7. The shaped article according to item 6 above, wherein the silicon-containing flame retardant is a polyorganosiloxane comprising at least one unit selected from the group consisting of an M unit represented by formula R₃SiO_{0.5}; a D unit represented by formula R₂SiO_{1.0}; a T unit represented by formula RSiO_{1.5}; and a Q unit represented by formula SiO_{2.0}, wherein each R independently represents a hydrocarbon group having 1 to 20 carbon atoms.

8. The shaped article according to any one of items 1 to 7 above, which is pellets.

9. The shaped article according to any one of items 1 to 7 above, which is a utility article.

Hereinbelow, the present invention is described in detail.

The resin composition used for producing the shaped article of the present invention is a flame retardant polycarbonate resin composition comprising a resin component (A) consisting of an aromatic polycarbonate or mainly comprising an aromatic polycarbonate, and a non-halogen flame retardant (B).

The resin component (A) comprises an aromatic polycarbonate as an essential component, and optionally a polymer other than an aromatic polycarbonate. Examples of optional polymers (other than an aromatic polycarbonate) which can be used in the resin component (A) include a rubber polymer, a thermoplastic resin other than an aromatic polycarbonate, and a thermosetting resin. Of these polymers, a rubber polymer and a thermoplastic resin other than an aromatic polycarbonate are preferred, and a thermoplastic resin other than an aromatic polycarbonate is most preferred.

In the resin component (A), the ratio of the aromatic polycarbonate to the optional polymer is generally from 50/50 to 100/0, preferably from 60/40 to 100/0, more preferably from 70/30 to 100/0.

With respect to the aromatic polycarbonate, the rubber polymer, and the thermoplastic resin other than an aromatic polycarbonate, which can be used in the resin component (A), an explanation is made below, referring to specific examples thereof.

First, an explanation is made with respect to the aromatic polycarbonate, which is an essential component of the resin component (A).

The aromatic polycarbonate may be either a homopolymer or a copolymer. It is preferred that the aromatic polycarbonate has a viscosity average molecular weight of from 10,000 to 100,000.

Examples of methods for producing the aromatic polycarbonate include a phosgene process in which phosgene is blown into a solvent containing a bifunctional phenolic compound and a caustic alkali, and a transesterification process in which, for example, a bifunctional phenolic compound and diethyl carbonate are subjected to a transesterification reaction in the presence of a catalyst.

Examples of the above-mentioned bifunctional phenolic compounds include 2,2′-bis(4-hydroxyphenyl)propane, 2,2′-bis(4-hydroxy-3,5-dimethylphenyl)propane, bis(4-hydroxyphenyl)methane, 1,1′-bis(4-hydroxyphenyl)ethane, 2,2′-bis(4-hydroxyphenyl)butane, 2,2′-bis(4-hydroxy-3,5-di phenyl)butane, 2,2′-bis(4-hydroxy-3,5-dipropylphenyl)propane, 1,1′-bis(4-hydroxyphenyl)cyclohexane and 1-phenyl-1,1′-bis(4-hydroxyphenyl)ethane. Of these, 2,2′-bis(4-hydroxyphenyl)propane (i.e., bisphenol A) is preferred. These bifunctional phenolic compounds can be used individually or in combination.

Next, an explanation is made with respect to the rubber polymer which can be used in the resin component (A).

It is preferred that the rubber polymer has a glass transition temperature (Tg) of −30° C. or lower. When the rubber polymer has a glass transition temperature higher than −30° C., the impact resistance of the final shaped article tends to become unsatisfactory.

Examples of rubber polymers include the following two types of polymers:

(i) rubbers, such as diene rubbers (e.g., polybutadiene, a styrene/butadiene copolymer and an acrylonitrile/butadiene copolymer), saturated rubbers obtained by hydrogenating the diene rubbers mentioned above, an isoprene rubber, a chloroprene rubber, acrylic rubbers (e.g., polybutyl acrylate), an ethylene/propylene copolymer rubber, an ethylene/propylene/diene terpolymer rubber (EPDM), and an ethylene/octene copolymer rubber (each of the rubbers mentioned above may be either in a cross-linked form or in a non-cross-linked form), and

(ii) thermoplastic elastomers containing at least one of the rubber polymers enumerated in item (i) above.

As the thermoplastic elastomers mentioned in item

(ii) above, especially preferred is a styrene polymercontaining thermoplastic elastomer. Examples of styrene polymer-containing thermoplastic elastomers include a block copolymer comprised of aromatic vinyl monomer units and conjugated diene monomer units, and a hydrogenated or epoxidated block copolymer obtained by partially hydrogenating or partially epoxidating the conjugated diene monomer units of the above block copolymer.

Examples of aromatic vinyl monomers used for producing the block copolymer (i.e., styrene polymercontaining thermoplastic elastomer) include styrene, α-methylstyrene, p-methylstyrene, p-chlorostyrene, p-bromostyrene and 2,4,5-tribromostyrene. Of these aromatic vinyl monomers, styrene is most preferred. Copolymers of styrene with any of other aromatic vinyl monomers mentioned above can also be used, wherein the copolymers contain styrene as a main component.

Examples of conjugated diene monomers used for producing the block copolymer (i.e., styrene polymer-containing thermoplastic elastomer) include 1,3-butadiene and isoprene.

Preferred examples of the above-mentioned block copolymers (i.e., styrene polymer-containing thermoplastic elastomers) include the following block copolymers (in the following explanation, S represents a polymer block comprised of aromatic vinyl monomer units, and B represents a polymer block comprised of conjugated diene monomer units and/or a partial hydrogenation product thereof):

(1) linear block copolymers having block configurations represented by the formulae: SB, S(BS)ₙ and S(BSB)ₘ, wherein n represents an integer of from 1 to 3 and m represents an integer of 1 or 2; and

(2) star-shaped block copolymers having a block configuration represented by the formula: (SB)ₖ^{X}, wherein k represents an integer of from 3 to 6, and X represents a residue of a coupling agent, such as silicon tetrachloride, tin tetrachloride, or a polyepoxy compound, and wherein the central portion of the star-shaped block copolymer is formed by the residue X and the B blocks bonded to the residue X.

Of these block copolymers, preferred are linear block copolymers which have a diblock configuration “SB”, a triblock configuration “SBS”, and a tetrablock configuration “SBSB”, respectively.

The use of any of the above-mentioned thermoplastic elastomers in the resin component (A) is advantageous in that, even when the resultant resin composition is molded to produce a shaped article having a large thickness, the lowering of the impact strength of the shaped article can be prevented. When such a resin composition (which contains the resin component (A) containing the thermoplastic elestomer) further contains the below-mentioned styrene copolymer as a compatibility agent, the final shaped article exhibits a remarkably improved impact strength.

With respect to the thermoplastic resin which can be used in the resin component (A), an explanation is made below.

There is no particular limitation with respect to the thermoplastic resin so long as the thermoplastic resin is compatible with the non-halogen flame retardant (B) or can be uniformly dispersed in the non-halogen flame retardant (B). Examples of such thermoplastic resins include styrene polymer resins, polyphenylene ether resins, olefin polymer resins, vinyl chloride polymer resins, polyamide resins, polyester resins, polyphenylene sulfide resins and polymethacrylate resins. Of these thermoplastic resins, styrene polymer resins, polyphenylene ether resins and olefin polymer resins are extremely preferred. These thermoplastic resins can be used individually or in combination.

With respect to the styrene polymer resins, polyphenylene ether resins and olefin polymer resins, which are mentioned above as examples of the thermoplastic resin usable in the resin component (A), an explanation is made below, referring to specific examples thereof.

First, the styrene polymer resins are explained below.

Examples of styrene polymer resins usable in the resin component (A) include a rubber-modified styrene polymer resin, a non-rubber-modified styrene polymer resin, and a combination thereof. Of these styrene polymer resins, preferred are a rubber-modified styrene polymer resin, and a combination of a rubber-modified styrene polymer resin and a non-rubber-modified styrene polymer resin.

In the present invention, the term “rubber-modified styrene polymer resin” means a resin comprising an aromatic vinyl polymer matrix having rubber polymer particles dispersed therein. The rubber-modified styrene polymer resin is obtained by graft polymerizing an aromatic vinyl monomer and optionally a vinyl comonomer copolymerizable with the aromatic vinyl monomer on a rubber polymer by conventional polymerization method, such as bulk polymerization, emulsion polymerization or suspension polymerization.

Examples of rubber-modified styrene polymer resins usable in the resin component (A) include a high impact polystyrene (HIPS), an ABS resin (acrylonitrile/butadiene/styrene copolymer), an AAS resin (acrylonitrile/acrylic rubber/styrene copolymer) and an AES resin (acrylonitrile/ethylene-propylene rubber/styrene copolymer). Of these rubber-modified styrene polymer resins, a HIPS and an ABS resin are preferred.

With respect to the above-mentioned rubber polymer which is used in the rubber-modified styrene polymer, it is preferred that the rubber polymer has a glass transition temperature (Tg) of −30° C. or lower. When the rubber polymer has a glass transition temperature higher than −30° C., the impact resistance of the shaped article tends to be low.

Examples of rubber polymers which are used in the rubber-modified styrene polymer include diene rubbers, such as polybutadiene, styrene-butadiene copolymer and acrylonitrile-butadiene copolymer; saturated rubbers obtained by hydrogenating the diene rubbers mentioned above; an isoprene rubber; a chloroprene rubber; acrylic rubbers, such as polybutyl acrylate; an ethylene/propylene copolymer rubber; an ethylene/propylene/diene terpolymer (EPDM); and an ethylene/octene copolymer rubber. Of these rubbers, diene rubbers are preferred.

Examples of aromatic vinyl monomers which can be graft-polymerized on the above-mentioned rubber polymers include styrene, α-methylstyrene and p-methylstyrene. Of these aromatic vinyl monomers, styrene is most preferred. The aromatic vinyl monomer may be used in the form of a mixture containing styrene as a main component and any of the aromatic vinyl monomers (other than styrene) mentioned above (i.e., α-methylstyrene and p-methylstyrene).

Examples of the above-mentioned optional vinyl comonomers which are copolymerizable with the aromatic vinyl monomer include unsaturated nitriles, such as acrylonitrile and methacrylonitrile, an alkyl acrylate (wherein the alkyl group has 1 to 8 carbon atoms), α-methylstyrene, acrylic acid, methacrylic acid, maleic anhydride and N-substituted maleimide.

Of the above-exemplified optional vinyl comonomers, the unsaturated nitrile is used, for example, when it is necessary to improve the oil resistance of the shaped article. The alkyl acrylate is used, for example, when it is necessary to lower the melt viscosity of the resin component (A) during the blending thereof with the flame retardant (B). Further, each of the α-methylstyrene, the acrylic acid, the methacrylic acid, maleic anhydride and the N-substituted maleimide is used, for example, when it is necessary to enhance the heat resistance of the shaped article.

When the aromatic vinyl monomer is used in combination with the optional vinyl comonomer copolymerizable therewith, the amount of the optional vinyl comonomer is 40% by weight or less, based on the total weight of the aromatic vinyl monomer and the optional vinyl comonomer.

In the rubber-modified styrene polymer resin usable in the resin component (A), the ratio of the weight of the rubber polymer to the total weight of the aromatic vinyl monomer and the optional vinyl comonomer is preferably in the range of from 5/95 to 80/20, more preferably from 10/90 to 50/50. When the ratio is within the above-mentioned range, the final shaped article exhibits an improved balance of impact resistance and stiffness.

The diameter of the rubber particles in the rubber-modified styrene polymer resin usable in the resin component (A) is preferably in the range of from 0.1 to 5.0 μm, more preferably from 0.2 to 3.0 μm. When the rubber particle diameter is within the above-mentioned range, especially, the impact resistance of the shaped article is enhanced.

With respect to the rubber-modified styrene polymer resin which comprises an aromatic vinyl polymer matrix having rubber polymer particles dispersed therein, the reduced viscosity ηₛₚ/c of the polymer constituting the matrix (which is a yardstick for the molecular weight of the rubber-modified styrene polymer resin) is preferably in the range of from 0.30 to 0.80 dl/g, more preferably from 0.40 to 0.60 dl/g. The reduced viscosity ηₛₚ/c is measured with respect to a 0.5 g/dl solution of the aromatic vinyl polymer (constituting the matrix of the rubber-modified styrene polymer resin) in a solvent at 30° C., wherein toluene is used as the solvent when the aromatic vinyl polymer is polystyrene, and methyl ethyl ketone is used as the solvent when the aromatic vinyl polymer is an unsaturated nitrile/aromatic vinyl copolymer. The reduced viscosity ηₛₚ/c of the aromatic vinyl polymer used in the rubber-modified styrene polymer resin usable in the resin component (A) can be controlled by adjusting the polymerization conditions for producing the aromatic vinyl polymer, such as the amount of the polymerization initiator, the polymerization temperature and the amount of the chain transfer agent.

Especially when it is desired that the shaped article exhibit an excellent heat resistance and an excellent oil resistance, it is preferred that the above-mentioned rubber-modified styrene polymer resin usable in the resin component (A) is a syndiotactic styrene polymer, which is a crystalline styrene polymer.

When a HIPS is used as the above-mentioned rubber-modified styrene polymer resin, from the viewpoint of improving the compatibility of the HIPS with the aromatic polycarbonate (which is the essential component of the resin component (A)), it is preferred that a styrene copolymer is used as a compatibility agent. As an example of such a styrene copolymer used as a compatibility agent, there can be mentioned a compatibility agent described in WO 95/35346. This compatibility agent is a styrene copolymer comprising at least one copolymer selected from the group consisting of:

(a) a copolymer comprising an aromatic vinyl monomer and a comonomer copolymerizable with the aromatic vinyl monomer; and

(b) a graft copolymer comprising a rubber polymer (having a glass transition temperature (Tg) of −30° C. or lower) having graft-polymerized thereon an aromatic vinyl monomer (M1) and a monomer (M2) copolymerizable with the aromatic vinyl monomer (M1), wherein the monomers (M1) and (M2) may form homopolymers of (M1) and (M2) and/or a copolymer of (M1) and (M2).

The styrene copolymer as the compatibility agent has a non-uniform composition, i.e., the styrene copolymer is non-uniform with respect to the distribution of the different monomer units forming the styrene copolymer. Due to such non-uniform composition, copolymer chains constituting the styrene copolymer exhibit different solubility parameter (SP) values, wherein the difference between the maximum SP value and the minimum SP value is from 0.3 to 1.0 [(cal/cm³)^{½}], and wherein the average SP value is in the range of from 10.6 to 11.2 [(cal/cm³)^{½}].

With respect to the polyphenylene ether resin (i.e. a polyether having aromatic rings in the main chain thereof) which is a thermoplastic resin usable in the resin component (A), an explanation is made below.

Specific examples of preferred polyphenylene ether resins include poly(2,6-dimethyl-1,4-phenylene ether), and a copolymer of 2,6-dimethylphenol and 2,3,6-trimethylphenol. Of these polyphenylene ether resins, poly(2,6-dimethyl-1,4-phenylene ether) is especially preferred. The reduced viscosity ηₛₚ/c of the polyphenylene ether resin (as measured with respect to a 0.5 g/dl chloroform solution of the resin at 30° C.) is preferably in the range of from 0.20 to 0.70 dl/g, more preferably from 0.30 to 0.60 dl/g. The reduced viscosity ηₛₚ/c of the polyphenylene ether resin can be controlled by appropriately selecting, for example, the amount of a catalyst used in the production of the polyphenylene ether resin.

With respect to the olefin polymer resin which is a thermoplastic resin usable in the resin component (A), an explanation is made below.

As an example of the olefin polymer resin, there can be mentioned a partially or completely crosslinked thermoplastic resin comprising a crosslinkable rubber polymer and an olefin polymer. Such a thermoplastic resin can be produced by subjecting a mixture of the crosslinkable rubber polymer and the olefin polymer to a dynamic crosslinking reaction in the presence of a crosslinking agent and an auxiliary crosslinking agent (for example, by the use of an extruder).

As the above-mentioned crosslinkable rubber polymer, an ethylene/α-olefin copolymer is preferred. It is more preferred that the ethylene/α-olefin copolymers is a copolymer of ethylene with a C₃-C₂₀ α-olefin, and it is still more preferred that the ethylene/α-olefin copolymers is a copolymer of ethylene with a C₆-C₁₂ α-olefin, which is produced using a metallocene catalyst.

As the above-mentioned olefin polymer used in olefin polymer resin usable in the resin component (A), a propylene polymer is preferred. Examples of propylene polymers include isotactic polypropylenes (isotactic homopolymers of propylene) and isotactic copolymers (inclusive of block copolymers and random copolymers) of propylene with another α-olefin, such as ethylene, 1-butene, 1-pentene or 1-hexene.

The non-halogen flame retardant (B) in the present invention is a flame retardant which contains no halogen atom except fluorine. That is, the non-halogen flame retardant (B) does not contain chlorine, bromine and iodine atoms, but may contain a fluorine atom.

Examples of the non-halogen flame retardant (B) include a silicon-containing flame retardant, a sulfur-containing flame retardant, a phosphorus-containing flame retardant, a nitrogen-containing flame retardant, an inorganic flame retardant other than mentioned above, a fibrous flame retardant and a char-forming flame retardant. Among these flame retardants, preferred are a silicon-containing flame retardant, a phosphorus-containing flame retardant, a nitrogen-containing flame retardant and an inorganic flame retardant other than mentioned above. More preferred are a silicon-containing flame retardant and a phosphorus-containing flame retardant, and most preferred is a silicon-containing flame retardant. In the present invention, the above-mentioned flame retardants may be used either individually or in combination.

In the present invention, the non-halogen flame retardant (B) is preferably used in an amount of from 0.001 to 100 parts by weight, more preferably from 0.1 to 50 parts by weight, most preferably from 1 to 20 parts by weight, relative to 100 parts by weight of the resin component (A).

With respect to the above-exemplified flame retardants (i.e., a silicon-containing flame retardant, a sulfur-containing flame retardant, a phosphorus-containing flame retardant, a nitrogen-containing flame retardant, an inorganic flame retardant other than mentioned above, a fibrous flame retardant and a char-forming flame retardant) usable as the flame retardant (B), explanations are made below.

As the silicon-containing flame retardant, organosilicon compounds are preferred. Among the organosilicon compounds, more preferred is a polyorganosiloxane, such as silicone or an organosilicate.

The polyorganosiloxane may be in the form of an oil, a resin or a rubber.

As an example of the polyorganosiloxane in the form of an oil, there can be mentioned a linear polydiorganosiloxane. It is preferred that the linear polydiorganosiloxane has aromatic groups. Further, it is preferred that the linear polydiorganosiloxane exhibits a kinetic viscosity of 10 centistokes or more, more advantageously 100 centistokes or more, most advantageously 1,000 centistokes or more, as measured at 25° C. in accordance with JIS-K2410.

Examples of polyorganosiloxane resins include a polyorganosiloxane having a branched structure and a silicone resin having a three-dimensional network structure, each comprising at least one unit selected from the group consisting of M unit which is monofunctional and represented by formula R₃SiO_{0.5}; D unit which is bifunctional and represented by formula R₂SiO; T unit which is trifunctional and represented by formula RSiO_{1.5}; Q unit which is tetrafunctional and represented by formula SiO_{2.0}; X unit and Y unit which contain an alkoxy group or an aryloxy group and are represented by formulae R(RO)SiO_{2.0} and (RO)₂SiO_{3.0}, respectively; wherein each R in the above-mentioned formulae independently represents a hydrocarbon group having 1 to 20 carbon atoms. Preferred examples of R include a methyl group, an ethyl group, a butyl group, a phenyl group and a benzyl group. Among these, more preferred are a methyl group and a phenyl group. The use of a polyorganosiloxane having a phenyl group content of 10 mole % or more as the flame retardant (B) is advantageous in that the final shaped article exhibits excellent water resistance, thermal stability and compatibility with aromatic resins (such as the aromatic polycarbonate resin used in the resin component (A)).

As an example of the polyorganosiloxane rubber, there can be mentioned a vulcanization product of a gum-like linear polydiorganosiloxane having a high molecular weight.

Further, modified polyorganosiloxanes may also be used as the flame retardant (B). Examples of modified polyorganosiloxanes include modification products of the above-mentioned polyorganosiloxanes, which are modified by incorporation of at least one group selected from the group consisting of an epoxy group, an amino group, a mercapto group, a methacryl group and the like.

Further, as a polyorganosiloxane, a polycarbonate (PC)/silicone copolymer and an acrylic rubber/silicone composition can also be used.

Among the above-mentioned polyorganosiloxanes, especially preferred is a polyorganosiloxane which contains at least one unit selected from the group consisting of M unit of formula R₃SiO_{0.5}; D unit of formula R₂SiO_{1.0}; T unit of formula RSiO_{1.5}; and Q unit of formula SiO_{2.0} (with the proviso that each R independently represents a hydrocarbon group having 1 to 20 carbon atoms).

Examples of sulfur-containing flame retardants usable as the flame retardant (B) include metal salts of organic sulfonic acids, such as potassium trifluorobenzenesulfonate, potassium perfluorobutanesulfonate, potassium diphenylsulfone-3-sulfonate; metal salts of aromatic sulfonimides; and aromatic polymers (such as polystyrene and polyphenylene ether) having bonded to aromatic rings thereof a metal salt, an ammonium salt or a phosphonium salt of sulfonic acid or sulfuric acid (e.g., an alkali metal salt of polystyrenesulfonic acid). Further, aromatic polymers (such as polystyrene and polyphenylene ether) having bonded to aromatic rings thereof a metal salt, an ammonium salt or a phosphonium salt of phosphoric acid or boric acid have a function similar to that of the above-mentioned sulfur-containing flame retardants and, hence, can also be used in the present invention.

The above-mentioned sulfur-containing flame retardants promote a decarboxylation reaction especially when the shaped article is on fire, thereby improving the flame retardancy of the shaped article. When the alkali metal salt of a polystyrenesulfonic acid is used as a sulfur-containing flame retardant, the sulfonic acid metal salt portions of the alkali metal salt of a polystyrenesulfonic acid function as crosslinking points when the shaped article is on fire, thereby greatly contributing to the formation of a char coating.

Examples of phosphorus-containing flame retardants usable as the flame retardant (B) include an organic phosphorus-containing flame retardant, a red phosphorus-containing flame retardant and an inorganic phosphorus-containing flame retardant.

Examples of organic phosphorus-containing flame retardants include a phosphine, a phosphine oxide, a bisphosphine, a phosphonium salt, a phosphinic acid salt, a phosphoric ester and a phosphorous ester. More specific examples of organic phosphorus-containing flame retardants include triphenyl phosphate, methylneopentyl phosphite, pentaerythritol diethyl diphosphite, methyl neopentyl phosphonate, phenyl neopentyl phosphate, pentaerythritol diphenyldiphosphate, dicyclopentyl hypodiphosphate, dineopentyl hypophosphite, phenylpyrocatechol phosphite, ethylpyrocatechol phosphate and dipyrocatechol hypodiphosphate. Among the above-mentioned phosphorous-containing flame retardants, preferred are a monomeric aromatic phosphoric ester and an aromatic phosphoric ester oligomer (obtained by condensation polymerization).

Examples of red phosphorus-containing flame retardants include not only an ordinary red phosphorus but also:

(i) a red phosphorus product obtained by coating red phosphorus with a film of a metal hydroxide, such as aluminum hydroxide, magnesium hydroxide, zinc hydroxide or titanium hydroxide;

(ii) another red phosphorus product obtained by coating red phosphorus with a film composed of a mixture of a metal hydroxide (such as aluminum hydroxide, magnesium hydroxide, zinc hydroxide and titanium hydroxide) or a thermosetting resin; and

(iii) still another red phosphorus product obtained by coating red phosphorus with a double-film layer comprising an inner film composed of a metal hydroxide (such as aluminum hydroxide, magnesium hydroxide, zinc hydroxide or titanium hydroxide) and an outer film composed of a thermosetting resin.

Examples of inorganic phosphorus-containing flame retardants include ammonium polyphosphate, a composite flame retardant containing ammonium polyphosphate and a nitrogen compound, and a phosphazene compound. Among these inorganic phosphorous-containing flame retardants, especially preferred is a compound having an aromatic group and having a structure in which a phosphorus atom is bonded to a nitrogen atom through a double bond. Examples of such especially preferred compounds include a cyclic phosphazene and a linear phosphazene. Among phosphazene compounds, from the viewpoint of achieving a good compatibility with an aromatic polycarbonate contained in the resin composition (A), preferred is a phosphazene compound having, as an aromatic group, a phenyl group, a cresyl group, a xylyl group or a bisphenyl group. Specific examples of such phosphazene compounds include phenoxypropoxyphosphazenes, diphenoxyphosphazenes, phenoxyaminophosphazenes, and phenoxyfluoroalkylphosphazenes. These phosphazene compounds can be obtained by subjecting a corresponding chlorophosphazene compound to a substitution reaction with an alcohol or a phenol.

With respect to the above-mentioned nitrogen-containing flame retardants, such flame retardants are conventionally used as an auxiliary flame retardant for improving flame retardancy of resin compositions containing a phosphorous-containing flame retardant. Representative examples of nitrogen-containing flame retardants include compounds having a triazine skeleton (i.e., triazine compounds). More specific examples of the above-mentioned triazine compounds include melamine, melam, melem, mellon (a product obtained by the ammonia-liberating reaction of melem at 600° C. or higher, in which three molecules of ammonia are liberated from three molecules of melem), melamine cyanurate, melamine phosphate, succinoguanamine, adipoguanamine, methylglutaroguanamine, a melamine resin and a BT resin. Among the above-mentioned triazene compounds, melamine cyanurate is preferred from the viewpoint of less volatilization.

Examples of inorganic flame retardants other than the above-mentioned silicon-containing flame retardants, sulfur-containing flame retardants, phosphorous-containing flame retardants and nitrogen-containing flame retardants, which can be used in the present invention, include silica, aluminum hydroxide, magnesium hydroxide, dolomite, hydrotalcite, calcium hydroxide, barium hydroxide, basic magnesium carbonate, zirconium hydroxide, a hydrate of an inorganic metal compound (such as tin oxide hydrate), a metal oxide (such as aluminum oxide, iron oxide, titanium oxide, manganese oxide, magnesium oxide, zirconium oxide, zinc oxide, molybdenum oxide, cobalt oxide, bismuth oxide, chromium oxide, tin oxide, antimony oxide, nickel oxide, copper oxide and tungsten oxide), a metal powder (such as powders of aluminum, iron, titanium, manganese, zinc, molybdenum, cobalt, bismuth, chromium, nickel, copper, tungsten, tin and antimony), zinc borate, zinc metaborate, barium metaborate, zinc carbonate, magnesium carbonate, calcium carbonate, and barium carbonate. Among the above-mentioned inorganic flame retardants, preferred are magnesium hydroxide, aluminum hydroxide, basic magnesium carbonate and hydrotalcite from the viewpoint of not only improving flame retardancy but also achieving economical advantage.

In the present invention, a fibrous flame retardant can also be used. A fibrous flame retardant is used for preventing the dripping of flaming particles when the shaped article is on fire. For realizing the incorporation of the fibrous flame retardant in the resin composition, there are two methods, namely, a method in which the fibrous flame retardant is produced before the production of the resin composition (comprising the components (A) and (B)) and then added to and melt-kneaded with the resin composition, and a method in which the non-fibrous material for the fibrous flame retardant is added to and melt-kneaded with the resin composition (comprising the components (A) and (B)), thereby causing the material to have a fibrous form during the melt-kneading. Examples of fibrous flame retardants include an aramid fiber, a polyacrylonitrile fiber and a fluorine-containing fiber resin.

With respect to the above-mentioned aramid fiber, it is preferred that the average diameter is 1 to 500 μm and the average fiber length is 0.1 to 10 mm. The aramid fiber can be produced by a method in which isophthalamide or polyparaphenylene terephthalamide is dissolved in an amide-containing polar solvent or sulfuric acid, and the resultant solution is subjected to wet spinning or dry spinning.

With respect to the above-mentioned polyacrylonitrile fiber, it is preferred that the average diameter is 1 to 500 μm and the average fiber length is 0.1 to 10 mm. The polyacrylonitrile fiber can be produced by a dry spinning method in which an acrylonitrile polymer is dissolved in a solvent (such as dimethylformamide), and the resultant solution is subjected to spinning under the flow of air at 400° C., or by a wet spinning method in which an acrylonitrile polymer is dissolved in a solvent (such as nitric acid), and the resultant solution is subjected to spinning in water.

The above-mentioned fluorine-containing fiber resin is a resin containing fluorine atoms therein. Specific examples of fluorine-containing fiber resins include polymonofluoroethylene, polydifluoroethylene, polytrifluoroethylene, polytetrafluoroethylene and a tetrafluoroethylene/hexafluoropropylene copolymer. If desired, the fluorine-containing fiber resin may be a copolymer obtained by copolymerizing a fluorine-containing monomer used in any of the above-exemplified fluorine-containing fiber resins with other monomers copolymerizable with the fluorine-containing monomer.

In the present invention, a char-forming flame retardant can also be used. As the char-forming flame retardant, it is preferred to use novolak resins and the like. Among novolak resins, especially preferred is a phenol novolak resin which can be obtained by subjecting a phenol and an aldehyde to a condensation polymerization reaction in the presence of an acid catalyst, such as sulfuric acid or hydrochloric acid.

In the present invention, with respect to the method for producing the resin composition (used for producing the shaped article of the present invention) from the resin component (A) and the non-halogen flame retardant (B), there is no particular limitation. Examples of such methods include a method in which the resin component (A) and the non-halogen flame retardant (B) are mixed with each other and the resultant mixture is melt-kneaded by using an extruder; a method in which the resin component (A) is melted by using an extruder, followed by addition of the non-halogen flame retardant (B), and the resultant mixture is melt-kneaded by using the extruder; and a method in which a master batch comprising a portion of the resin component (A) and the non-halogen flame retardant (B) is produced, followed by addition of the remainder of the resin component (A), and the resultant mixture is melt-kneaded.

If desired, the resin composition used for producing the shaped article of the present invention may optionally contain a processing aid, such as a mold release agent or a fluidity improver. Specific examples of processing aids include an aliphatic hydrocarbon, a higher fatty acid, a higher fatty acid ester, a higher fatty acid amide, a higher aliphatic alcohol, a metal soap, an organosiloxane wax, a polyolefin wax and a polycaprolactone. These processing aids can be used individually or in combination.

The amount of the processing aid is preferably from 0.01 to 20 parts by weight, more preferably from 0.5 to 10 parts by weight, most preferably from 1 to 5 parts by weight, relative to 100 parts by weight of the resin component (A).

For improving the light resistance of the shaped article of the present invention, the resin composition used for forming the shaped article may optionally contain a light resistance improver. Examples of light resistance improvers include an ultraviolet light absorber, a hindered amine light stabilizer, an antioxidant, a scavenger for an active species, a light blocking agent, a metal deactivating agent, and a light quenching agent. These light resistance improvers can be used individually or in combination.

The amount of the light resistance improver is preferably from 0.05 to 20 parts by weight, more preferably from 0.1 to 10 parts by weight, most preferably from 1 to 5 parts by weight, relative to 100 parts by weight of the resin component (A).

In the present invention, the term “shaped article” means a body having an invariable shape, which is obtained by melting a resin composition and molding the resultant molten resin composition, wherein the method for the melting and molding, and the shape and size of the body obtained are not particularly limited. The shaped article may be either an intermediate product (such as pellets) or a final product (such as a housing or chassis for office automation machines).

In the present invention, the term “pellets” means bodies (each having a rice grain-like shape) which are obtained by melt-kneading a resin composition by using an extruder or the like. Examples of methods for producing pellets include a method in which a resin composition is melt-kneaded, and the resultant melt-kneaded composition is cooled with water or the like to solidify the composition, followed by cutting the composition; and a method in which a resin composition is melt-kneaded, and the resultant, melt-kneaded composition is cooled with water so that the composition becomes semi-molten, followed by cutting the composition in a semi-molten state. The size of each pellet is generally approximately the same as the size of a grain of rice.

With respect to the shaped article of the present invention obtained by (1) melting the above-mentioned flame retardant polycarbonate resin composition comprising the resin component (A) consisting of an aromatic polycarbonate or mainly comprising an aromatic polycarbonate, and the non-halogen flame retardant (B), and (2) molding the resultant molten resin composition, it is required that the number of discrete particles, dispersed in the shaped article, each having a size of 50 μm or more, be 0 to 100/mm² as measured with respect to the surface of a flat sample cut out from the shaped article.

The term “flat sample cut out from the shaped article” means a flat flake cut out from the shaped article. Such a flat sample is generally obtained by cutting out a flat flake from the shaped article by ultramicrotomy (with respect to the ultramicrotomy, reference can be made to page 1436 of “Kagaku Daijiten (Encyclopedic Dictionary of Chemistry)”, published by TOKYO KAGAKU DOZIN CO., LTD., Japan, 1989). With respect to the size of the flat sample, there is no particular limitation so long as the flat sample can be used for the below-mentioned observation under a microscope. When the observation is conducted under an inverted metallurgical microscope, a sample having a length of about 0.5 mm, a width of about 0.5 mm² and a thickness of about 1 μm is frequently used.

The term “discrete particle, dispersed in the shaped article, having a size of 50 μm or more” means a particle present in the flat sample, which has a size of 50 μm or more, and which is discernible by an observation under a microscope. The “size” of the particle means the distance between the two most distant points on the circumference of the image of the particle shown in a photomicorgraph which is taken from right above the flat sample.

With respect to the morphology of the particle, there is no particular limitation.

The term “as measured with respect to the surface of the flat sample” means that the number of discrete particles, each having a size of 50 μm or more, which are discernible in a photomicrograph taken from right above the flat sample, is counted. As the microscope, an electron microscope, an optical microscope or the like can be used.

With respect to the number of the above-mentioned discrete particles each having a size of 50 μm or more, the number is preferably 50/mm² or less, more preferably 30/mm² or less, most preferably 10/mm² or less, as measured with respect to the surface of a flat sample cut out from the shaped article.

With respect to the source of the discrete particles, there is no particular limitation. In general, most of the discrete particles are derived from the non-halogen flame retardant (B).

As described above, the components of the shaped article of the present invention (especially, components derived from the non-halogen flame retardant (B)) are uniformly dispersed in the shaped article, so that the shaped article exhibits not only an excellent flame retardancy, but also excellent appearance, impact resistance and stability in quality (e.g., ability to suppress lowering of Izod impact strength of the shaped article, which occurs during a continuous molding of the above-mentioned molten resin composition).

As described above, the shaped article of the present invention is obtained by (1) melting a flame retardant polycarbonate resin composition comprising a resin component (A) consisting of an aromatic polycarbonate or mainly comprising an aromatic polycarbonate, and a non-halogen flame retardant (B), and (2) molding the resultant molten resin composition. In the present invention, it is preferred that the molten flame retardant polycarbonate resin composition which is being molded has carbon dioxide dissolved therein, so that the molten resin composition having carbon dioxide dissolved therein exhibits a shear melt viscosity which is lower than the shear melt viscosity exhibited by the resin composition having no carbon dioxide dissolved therein.

In this case, specifically, it is preferred that the molten resin composition having carbon dioxide dissolved therein exhibits a shear melt viscosity which is lowered by 10% or more, more advantageously by 20% or more, still more advantageously by 30% or more, relative to the shear melt viscosity exhibited by the resin composition having no carbon dioxide dissolved therein.

By molding the molten resin composition having carbon dioxide dissolved therein, it becomes possible to obtain the shaped article of the present invention which is advantageous in that the components of the shaped article are uniformly dispersed in the shaped article. The reason for this is as follows. By introducing carbon dioxide into the flame retardant polycarbonate resin composition, the melt viscosity of the resin composition is lowered, thereby leading to an improvement in the moldability of the resin composition. As a result, the components of the shaped article (especially, components derived from the flame retardant (B)) are caused to be uniformly dispersed in the shaped article.

The lowering of the melt viscosity of the resin composition suppresses heat generation during the molding thereof and, hence, suppresses the decomposition of the aromatic polycarbonate, so that the strength of the shaped article is improved.

When the shaped article (formed by solidifying the molded molten resin composition having carbon dioxide dissolved therein) is allowed to stand still in the air, the carbon dioxide gradually escapes from the shaped article into the air. The escape of the carbon dioxide from the shaped article does not leave voids in the shaped article. Therefore, the shaped article after the escape of the carbon dioxide retains the properties inherently possessed by the resin composition.

As described above, in the present invention, it is preferred that the molten flame retardant polycarbonate resin composition which is being molded has carbon dioxide dissolved therein, so that the molten resin composition having carbon dioxide dissolved therein exhibits a shear melt viscosity which is lower than the shear melt viscosity exhibited by the resin composition having no carbon dioxide dissolved therein. With respect to the timing of introduction of carbon dioxide into the resin composition, there is no particular limitation. That is, the introduction of carbon dioxide into the resin composition can be conducted at any of the time when the resin composition is in a solid state, the time when the resin composition is being melted, and the time when the resin composition is in a molten state. In general, carbon dioxide in a gaseous state is introduced into the resin composition.

As preferred methods for introducing carbon dioxide gas into the resin composition, there can be mentioned the following first and second methods.

In the first method, the resin composition in a particulate or powder form is placed in a carbon dioxide gas atmosphere to thereby cause the resin composition to absorb carbon dioxide gas. The amount of carbon dioxide gas absorbed by the resin composition varies depending on the pressure of the carbon dioxide gas atmosphere, the absorption time and the like. The pressure of the carbon dioxide gas atmosphere is generally about 0.09 MPa. The absorption time is generally about 24 hours. In this method, when the resin composition having carbon dioxide absorbed therein is molded, the resin composition in a particulate or powder form, which has carbon dioxide absorbed therein, is fed to a molding machine. During the molding of the resin composition which is conducted while heating, a part of the carbon dioxide contained in resin composition is evaporated from the resin composition, so that the amount of the carbon dioxide contained in the resin composition becomes smaller than the amount of the carbon dioxide absorbed by the resin composition before the molding. Therefore, it is preferred that the atmospher of paths for feeding the resin composition (e.g., a hopper of the molding machine) is a carbon dioxide gas atmosphere. In this case, as the molding machine, it is preferred to use an injection molding machine.

In the second method, carbon dioxide gas is dissolved in the resin composition which is being melted or has been melted in the cylinder of the molding machine. When the second method is employed, generally, the hopper of the molding machine and portions of the molding machine around the hopper are in a carbon dioxide gas atmosphere, and/or carbon dioxide gas is introduced into the molding machine at a portion thereof corresponding to the middle or front edge portion of the screw or cylinder of the molding machine. In the case where carbon dioxide gas is introduced into the molding machine at a portion thereof corresponding to the middle portion of the screw or cylinder of the molding machine, it is preferred that, at around a portion of the molding machine where carbon dioxide is introduced the depth of the groove of the screw is large so as to lower the pressure of the resin composition in the cylinder. Further, for uniformly dissolving and dispersing the introduced carbon dioxide in the resin composition, it is preferred that the screw is provided with a mixing device, such as a dulmage or a kneading pin; and/or that a conduit for introducing the resin composition into the molding machine is equipped with a static mixer.

In the second method, it is preferred that the molding of the resin composition is conducted by injection molding. As an injection molding machine, either an in-line screw type injection molding machine or a screw preplasticating type injection molding machine can be used. However, the use of a screw preplasticating type injection molding machine is especially preferred, because it is easy to alter not only the design of the screw at an extrusion region of the molding machine at which the resin composition is melted, but also the position at which carbon dioxide gas is introduced into the molding machine.

As one of the preferred methods for molding the molten resin composition having carbon dioxide dissolved therein, there can be mentioned a method in which the molten resin composition having carbon dioxide dissolved therein is subjected to injection molding, wherein the molten resin composition is injected into a mold cavity which has been pressurized by carbon dioxide gas (as a counter gas) to a pressure level wherein no foaming occurs at a flow front of the molten resin composition in the cavity.

In this method, the mold cavity which has been pressurized by carbon dioxide gas is required to have an internal pressure at a level wherein no foaming occurs at a flow front of the molten resin composition in the cavity (i.e., no trace of foaming is observed at the surface of the shaped article produced). On the other hand, from the viewpoint of not only minimizing the amount of carbon dioxide used per shaped article, but also rendering easy the sealing of the mold cavity and simplifying the structure of a gas feeding apparatus used, it is preferred that the mold cavity which has been pressurized by carbon dioxide gas has a low internal pressure. Therefore, it is most preferred that the mold cavity which has been pressurized by carbon dioxide gas has the lowest internal pressure among the internal pressures wherein no foaming occurs at a flow front of the molten resin composition in the cavity. When the mold cavity which has been pressurized by carbon dioxide gas has an internal pressure of more than 15 MPa, disadvantages are likely to be caused wherein the force exerted by the gas (in the mold cavity) to open the mold becomes too strong and it becomes difficult to keep the mold closed and securely seal the mold.

It is also possible to use, as a counter gas, a gas other than carbon dioxide gas. Examples of such counter gases other than carbon dioxide gas include gases (such as air and nitrogen) which are inert to the resin composition. These gases which are inert to the resin composition can be used individually or in combination. However, the use of carbon dioxide gas is especially preferred, since carbon dioxide gas has a high solubility in a thermoplastic resin (such as the aromatic polycarbonate used in the resin component (A) of the resin composition), and greatly improves the transferability of the surface morphology of the mold cavity to the shaped article.

With respect to such transferability, in the case where a non-crystalline resin is used as the resin component (A) of the resin composition and the mold cavity is pressurized by carbon dioxide gas, the higher the internal pressure of the mold cavity, the higher the transferability (see Japanese Patent Application Nos. Hei 9-236763 and Hei 10-46903). Therefore, when it is desired to achieve a high transferability, it is preferred to increase the pressure of the mold cavity to a level as high as possible, taking into consideration the mold clamping force of the molding machine and the sealing property of the mold. In this case, it is preferred that the gas in the mold cavity has a high carbon dioxide content, specifically, a carbon dioxide content of 80% by volume or more. The temperature of the gas in the mold cavity is not particularly limited; for example, not only a gas having room temperature but also a heated gas (which generally has a temperature in the range of from more than room temperature to 300° C.) can be favorably used. When a heated gas is used, it is preferred to use, as the heated gas, a gaseous mixture of carbon dioxide and a gas obtained by vaporizing a liquid in which carbon dioxide exhibits a high solubility.

With respect to the above-mentioned method in which the molten resin composition having carbon dioxide dissolved therein is subjected to injection molding, wherein the molten resin composition having carbon dioxide dissolved therein is injected into a mold cavity which has been pressurized by carbon dioxide gas (as a counter gas) to a pressure level wherein no foaming occurs at a flow front of the molten resin composition in the cavity, this method can be applicable to the production of an injection-molded hybrid article as explained below. That is, by the above-mentioned method, it is possible to produce a shaped article comprising a core formed by the flame retardant polycarbonate resin composition comprising the resin component (A) and the non-halogen flame retardant (B), and a surface layer formed on the core by a thermoplastic resin (C), wherein the surface layer has a uniform thickness. As an example of especially preferred methods for producing an injection-molded hybrid article, there can be mentioned a method in which a flame retardant polycarbonate resin composition (having 0.2 to 3% by weight of carbon dioxide dissolved therein) and a thermoplastic resin (C) are simultaneously or successively injected into a mold cavity to thereby obtain a shaped article. The type of the thermoplastic resin (C) may be the same as or different from the type of the resin component (A) of the resin composition used in the present invention. Further, the molecular weight of the thermoplastic resin (C) may also be the same as or different from the molecular weight of the resin component (A) of the resin composition used in the present invention. The type and molecular weight of the thermoplastic resin (C) may be appropriately selected.

In the production of the injection-molded hybrid article, which has a surface layer composed of a thermoplastic resin (C), when a thermoplastic resin (C) having an excellent heat resistance, chemical resistance and physical properties is used, it becomes possible to obtain a molded article which is improved with respect to various properties.

As described above, the shaped article of the present invention exhibits not only an excellent flame retardancy, but also excellent appearance, impact resistance and stability in quality (e.g., ability to suppress lowering of Izod impact strength of the shaped article, which occurs during a continuous molding of the above-mentioned molten resin composition), so that the shaped article of the present invention can be advantageously used in various application fields, such as automobile parts, parts for use in household electric appliances and parts for office automation machines.

Specifically, the shaped article of the present invention can be advantageously used as, for example: housings, chassis or parts for household electric appliances, such as a VTR, a distribution switchboard, a television set, an audio player, a capacitor, a plug socket for domestic use, a radio cassette recorder, a video cassette, a video disk player, an air conditioner, a humidifier and an electric warm air furnace; a main frame for a CD-ROM drive; housings, chassis or parts for office automation machines, such as a printer, a fax machine, a CRT, a word processor, a copying machine (such as a PPC), an electronic cash register, an office computer system, a floppy disk drive, a keyboard, a typewriter, a electric calculator, a toner cartridge and a telephone; electronic or electric materials, such as a connector, a coil bobbin, a switch, relay, a relay socket, an LED, a variable capacitor, an AC adapter, an FBT high-voltage bobbin, an FBT case, an IFT coil bobbin, a jack, a volume shaft and a motor part; and automobile parts, such as an instrument panel, a radiator grille, a cluster, a speaker grille, a louver, a console box, a defroster garnish, an ornament, a fuse box, a relay case and a connector shift tape.

### BEST MODE FOR CARRYING OUT THE INVENTION

Hereinbelow, the present invention will be described in more detail with reference to the following Examples and Comparative Examples, which should not be construed as limiting the scope of the present invention.

In the following Examples and Comparative Examples, various properties were measured and evaluated as follows.

(1) Number (per mm²) of discrete particles, dispersed in a shaped article, each having a size of 50 μm or more:

10 Flat samples, each having a length of 0.5 mm, a width of 0.5 mm² and a thickness of 1 μm, are randomly cut out from the surface of a shaped article by ultramicrotomy (see page 1436 of “Kagaku Daijiten (Encyclopedic Dictionary of Chemistry)”, published by TOKYO KAGAKU DOZIN CO., LTD., Japan, 1989). With respect to the 10 flat samples, the surfaces thereof are shaved using a diamond knife so that the samples become satisfactorily smooth. With respect to each of the resultant 10 samples, a photomicrograph thereof is taken from right above the sample by using an inverted metallurgical microscope (PEN 3, manufactured and sold by OLYMPUS OPTICAL CO., LTD., Japan). With respect to each of the obtained 10 photomicrographs, the number (per mm ) of discrete particles each having a size of 50 μm or more, which are shown in the photomicrograph, is counted. The average value of the numbers (of the discrete particles) counted with respect to the 10 photomicrographs is defined as the number (per mm²) of discrete particles, dispersed in the shaped article, each having a size of 50 μm or more.

(2) Weight of carbon dioxide in a molten resin composition

With respect to a shaped article produced from a molten resin composition having carbon dioxide dissolved therein, the weight of the shaped article immediately after the production thereof is measured. The shaped article is allowed to stand in a hot-air dryer for more than 24 hours, wherein the temperature of the hot-air dryer is about 30° C. lower than the glass transition temperature of the resin composition, to expel carbon dioxide from the shaped article until the weight of the shaped article becomes constant. Then, the weight of the thus obtained shaped article is measured. The difference in weight between the shaped article immediately after the production thereof and the shaped article whose weight has become constant is defined as the weight of carbon dioxide in the molten resin composition.

(3) Lowering ratio of the shear melt viscosity of a resin composition

With respect to a resin composition having no carbon dioxide dissolved therein, the shear melt viscosity (Pa·s) thereof is measured using a capillary rheometer (manufactured and sold by ROSAND, Switzerland) at a melting temperature of 250° C. and a shear rate of 1,000 sec⁻¹ under below-mentioned measurement conditions. The obtained value is used as the reference for fluidity of the resin composition.

| Measurement conditions: | |
|---|---|
| long die length: 16 mm | long die diameter: 1 mm |
| short die length: 0.25 mm | short die diameter: 1 mm |
| die entry angle: 180 deg. | |

With respect to the resin composition having carbon dioxide dissolved therein, the shear melt viscosity thereof is measured as follows. A free purge of the resin composition is conducted at a shear rate of about 1,000 sec⁻ using an injection molding machine (which is separately explained in detail in item “Injection molding machine” shown below) which has a nozzle having a diameter of 1 mm and a length of 5 mm. The pressure needed to conduct the free purge is measured, in terms of the pressure of the resin composition in the cylinder of the injection molding machine. The shear melt viscosity of the resin composition is obtained, based on the pressure needed to conduct the free purge.

The lowering ratio of the shear melt viscosity (%) of the resin composition is calculated by the following formula:

Lowering ratio of the shear melt viscosity (%)={1-(shear melt viscosity of the resin composition having no carbon dioxide dissolved therein)/(shear melt viscosity of the resin composition having carbon dioxide dissolved therein))}×100.

4) Flame retardancy:

The self-extinguishing properties of a ⅛ inch-thick specimen are evaluated in accordance with the VB (Vertical Burning) Method which is described in UL-94. The criteria for the evaluation of the self-extinguishing properties are as follows.

⊚: self-extinguished within less than 20 seconds,

◯: self-extinguished within 20 to less than 40 seconds,

Δ: it takes 40 seconds or more for the specimen to be self-extinguished, and

X: totally burnt.

5) Izod impact strength:

The Izod impact strength of a ¼ inch-thick, V-notched specimen is measured at 23° C. in accordance with ASTM-D256.

6) Ratio of change in Izod impact strength:

A resin composition having carbon dioxide dissolved therein is subjected to a continuous melt-extrusion for 10 hours using an injection molding machine (which is separately explained in detail in item “Injection molding machine” shown below), during which samples of the shaped article are taken every 1 hour, to thereby obtain 10 samples in total. The Izod impact strength values of the obtained 10 samples of a shaped article are measured, and the average Izod impact strength is obtained. With respect to each of the 10 samples, the ratio (%) of the found Izod impact strength thereof to the average Izod impact strength is alculated. Then, the average of the obtained 10 values of the above-mentioned ratio is calculated. The obtained value is defined as the ratio of change in Izod impact strength and is used as an index for the quality stability of a shaped article produced from the resin composition.

(7) Appearance of a shaped article:

A shaped article is visually observed and the appearance of the shaped article is evaluated by the following criteria:

⊚: the shaped article is smooth and the shaped article has an excellent appearance,

◯: the shaped article has a good appearance,

Δ: when visually observed, large discrete particles are found on the surface of the shaped article, and the shaped article is not smooth, and

X: the surface of the shaped article is rough due to non-uniform dispersion of the components in the shaped article.

In the Examples and Comparative Examples, as an aromatic polycarbonate which is the essential component of the resin component (A), a bisphenol A type polycarbonate (trade name: Calibre, manufactured and sold by Sumitomo Dow Limited, Japan) was used (hereinafter, this polycarbonate is referred to simply as “PC”).

In the Examples and Comparative Examples, as polymers (other than an aromatic polycarbonate) which are optional components of the resin component (A), the following polymers were used (with respect to the following polymers, abbreviations thereof are respectively indicated in parentheses):

A Nylon 6,6 (PA66), a nylon 6 (PA6), a polyethylene terephthalate (PET), a polybutylene terephthalate (PBT), an epichlorohydrin/bisphenol A condensation polymer (EP) (which is a thermoplastic epoxy resin), a high impact polystyrene (HIPS), an ABS resin (ABS), styrene/ethylene/butylene/styrene copolymer (SEBS), a styrene/butadiene copolymer (SB), a polyphenylene ether (PPE), a polypropylene (PP), an ethylene/octene copolymer (EO), a polyvinyl chloride (PVC), a polyphenylene sulfide (PPS), a polymethyl methacrylate (PMMA) and an EO/PP-crosslinked product (TPV).

The above-mentioned TPV is a crosslinked thermoplastic propylene polymer obtained by dynamic crosslinking conducted by melt-kneading and extruding a mixture of EO (ethylene/octene copolymer) and PP (polypropylene) (weight ratio: 50/50), an organic peroxide and triallyl isocyanurate by means of a twin-screw extruder.

In the Examples and Comparative Examples, as the non-halogen flame retardant (B), the following flame retardants were used:

1) Polyorganosiloxane

a straight chain methyl phenyl silicone (hereinafter referred to as “S1”) (composed of the above-mentioned D units);

a branched and crosslinked type methyl phenyl silicone (hereinafter referred to as “S2”) (composed of the above-mentioned D units and T units);

a branched and crosslinked type methyl phenyl silicone (hereinafter referred to as “S3”) (composed of the above-mentioned T units); and

a methyl phenyl silicone rubber (hereinafter referred to as “S4”).

S1 to S4 mentioned above are produced in substantially the same manner as described in Chapter 17 of the “Shirikoon Handobukku (Silicone Handbook)”, edited by Kunio Ito and published by The Nikkan Kogyo Shimbun Ltd., Japan, 1990. The kinetic viscosities of S1 to S3 measured at 25° C. in accordance with JIS-K2410 are each 500 centistokes. In each of S1 to S4, the molar ratio of methyl groups to phenyl groups is 50/50.

2) Salt of organic sulfonic acid

Potassium diphenylsulfone-3-sulfonate (manufactured and sold by UCB Japan Co. Ltd., Japan) (hereinafter referred to as “SF1”);

potassium perfluorobutanesulfonate (manufactured and sold by Dainippon Ink & Chemicals, Inc., Japan) (hereinafter referred to as “SF2”); and

tetrabuthylphosphonium polystyrenesulfonate (hereinafter referred to as “SF3”).

The above-mentioned SF3 is produced in substantially the same manner as described in Unexamined Japanese Patent Application Laid-Open Specification No. Hei 11-263902.

3) 1,3-phenylene-bis(diphenylphosphate), which is an oligomeric aromatic phosphoric ester derived from resorcinol (trade name: CR733S, manufactured and sold by Daihachi Chemical Industry Co., Ltd., Japan) (hereinafter referred to as “P1”).

4) Bisphenol A-bis(diphenylphosphate) (trade name: CR741, manufactured and sold by Daihachi Chemical Industry Co., Ltd., Japan) (hereinafter referred to as “P2”).

5) 1,3-phenylene-bis(dixylylphosphate) (trade name: PX200, manufactured and sold by Daihachi Chemical Industry Co., Ltd., Japan) (hereinafter referred to as “P3”).

6) Red phosphorus (trade name: RINKA FE, manufactured and sold by RINKAGAKU KOGYO CO., LTD., Japan) (hereinafter referred to as “P4”).

7) Ammonium polyphosphate (trade name: TERRAJU, manufactured and sold by CHISSO CORPORATION, Japan) (hereinafter referred to as “P5”).

8) Phenoxyphosphazen (hereinafter referred to as “P6”)

9) Magnesium hydroxide (trade name: KISUMA, manufactured and sold by KYOWA CHEMICAL INDUSTRY CO., LTD., Japan) (hereinafter referred to as “MOH”).

10) Melamine cyanurate (trade name: MC610, manufactured and sold by Nissan Chemical Industries, Ltd., Japan) (hereinafter referred to as “M1”).

11) Polytetrafluoroethylene (manufactured and sold by Daikin Industries, Ltd., Japan) (hereinafter referred to as “PTFE”).

In each of Comparative Examples 3 and 4, instead of a non-halogen flame retardant (B), decabromodiphenyloxide (manufactured and sold by ALBEMARLE CORPORATION, U.S.A.) (hereinafter referred to as “DBD”) was used.

The injection molding machine, mold and counter gas-feeding apparatus used in the Examples and Comparative Examples are as follows.

(Injection Molding Machine)

As an injection molding machine, a vented injection molding machine (SG125M-HP, manufactured and sold by SUMITOMO HEAVY INDUSTRIES, LTD., Japan) is used. As a screw, a 2-stage vent type screw is used which has a length/diameter ratio (L/D) of 24 and a diameter of 32 mm. As a nozzle, a needle type shut-off nozzle is used.

(Mold)

As a mold, a square flat plate-producing mold is used.

The cavity of the mold has a size of 100 mm×100 mm×2 mm. With respect to the flat plate-producing mold, the mold has a sprue having a length of 58 mm, wherein the sprue has a direct gate (having a diameter of 8 mm) which opens at the center of a cavity wall, and another opening (having a diameter of 3.5 mm) at the nozzle touch portion formed on the outer wall of the mold. For feeding and releasing a counter gas (i.e., carbon dioxide gas), a vent slit (having a depth of 0.05 mm) is formed in the cavity wall, wherein the slit communicates with a vent which is formed in the mold and connected with a counter gas feeding apparatus (which is separately explained in detail in item “Counter gas feeding apparatus for pressurizing the mold cavity” shown below) though a hole formed in the mold and a conduit. Around the above-mentioned vent slit and hole, the gaps between the parts constituting the mold are sealed with O-rings for gas sealing to render the mold cavity airtight.

(Counter Gas-feeding Apparatus for Pressurizing the Mold Cavity)

As a source of a counter gas (i.e., carbon dioxide gas), liquefied carbon dioxide is charged into a bomb, wherein the temperature of the bomb is maintained at 35° C. From the bomb, the carbon dioxide is discharged in a gaseous state, and passed through a warming apparatus, and then through a pressure reducing valve to adjust the pressure of the carbon dioxide to a predetermined level under which the carbon dioxide is maintained in a gaseous state. The carbon dioxide which has been passed through the pressure reducing valve is then introduced and stored in a gas storing vessel having a volume of 1,000 cm³, wherein the temperature of the vessel is maintained at about 40° C. An electromagnetic vent for feeding carbon dioxide gas is provided downstream of the gas storing vessel. Feeding of carbon dioxide gas to the mold cavity is conducted by opening the electromagnetic vent for feeding carbon dioxide gas while closing an electromagnetic vent for releasing carbon dioxide gas. During the operation of filling the mold cavity with carbon dioxide gas, the gas storing vessel is connected to the mold cavity. Immediately after completion of filling the mold cavity with the resin composition, the electromagnetic vent for feeding carbon dioxide gas is closed while opening the electromagnetic vent for releasing carbon dioxide gas, thereby releasing carbon dioxide gas from the mold.

### EXAMPLE 1

The above-mentioned bisphenol A type polycarbonate (PC) and the above-mentioned methylphenylsilicone (S1) were mixed with each other by means of a Henschel mixer to obtain a resin composition having a composition indicate in Table 1. The obtained resin composition was continuously introduced into a twin-screw extruder (40 mmφ, L/D=47) (ZSK-25, manufactured and sold by Werner Pfleiderer, Germany) having an inlet provided at a middle portion of the barrel thereof, to perform a continuous melt-extrusion of the resin composition at 240° C. for 10 hours, thereby obtaining a molten resin composition in the form of pellets. The screws used in the extruder were two double-threaded screws, each having a configuration wherein a kneading is effected in the extruder around the inlet thereof.

The thus obtained molten resin composition in the form of pellets was dried at 120° C. for 5 hours in a hot-air dryer to obtain dried resin composition pellets. The dried resin composition pellets were subjected to an injection molding at a cylinder temperature of 250° C. as follows.

The dried resin composition pellets were introduced into the above-mentioned vented injection molding machine to melt the resin composition at a cylinder temperature of 250° C., while feeding a pressurized carbon dioxide gas to the molding machine through the vent thereof, under conditions wherein the pressure of the carbon dioxide gas at the vent was 5 MPa and the screw revolution rate was 150 rpm, thereby obtaining a molten resin composition having carbon dioxide gas dissolved therein. The obtained molten resin composition having carbon dioxide gas dissolved therein was injected through the nozzle of the molding machine into the above-mentioned square flat plate-producing mold having a surface temperature of 80° C. to perform a counter pressure molding using carbon dioxide gas as a counter gas. Specifically, the counter pressure molding was performed by injecting the molten resin composition into a mold cavity of the mold, which had been pressurized by carbon dioxide gas fed from the above-mentioned counter gas-feeding apparatus, under conditions wherein the time taken for filling the mold cavity with the molten resin composition was 0.5 second and the counter pressure was 1 MPa. Under these conditions, the pressure needed to fill the mold cavity with the molten resin composition, in terms of the pressure of the resin composition present in the cylinder of the molding machine, was measured and found to be 211 MPa. After filling the mold cavity with the molten resin composition, the pressure of the molten resin composition in the cylinder was maintained at 190 MPa for 5 seconds, followed by cooling for 20 seconds. Then, the mold was opened and a shaped article was taken out from the mold.

The amount of carbon dioxide dissolved in the molten resin composition was measured by the above-mentioned method and found to be 0.4% by weight.

With respect to the obtained shaped article, various measurements and evaluations were conducted by the above-mentioned methods. The results are shown in Table 1.

As apparent from Table 1, with respect to the shaped article obtained in Example 1 (i.e., shaped article obtained by molding the molten resin composition which contained the resin component (A) and the non-halogen flame retardant (B) and which had been caused to have carbon dioxide dissolved therein, to thereby lower the melt viscosity by 10% or more), the number of discrete particles (each having a size of 50 μm or more) dispersed in the shaped article was in the range of from 0 to 100/mm² (specifically 12/mm²), and the shaped article exhibited excellent flame retardancy, impact resistance, quality stability (evaluated in terms of the ratio (%) of change in Izod impact strength) and appearance.

### Comparative Example 1

A shaped article was produced in substantially the same manner as in Example 1, except that a pressurized carbon dioxide gas was not fed to the molding machine through the vent thereof and that the mold cavity was not pressurized by carbon dioxide gas (fed from the counter gas-feeding apparatus in Example 1). The pressure needed to fill the mold cavity with the resin composition, in terms of the pressure of the resin composition present in the cylinder of the injection molding machine, was measured and found to be 235 MPa.

With respect to the obtained shaped article, various measurements and evaluations were conducted by the above-mentioned methods. The results are shown in Table 1.

As apparent from Table 1, with respect to the shaped article obtained in Comparative Example 1 (i.e., shaped article obtained by molding the molten resin composition which contained the resin component (A) and the non-halogen flame retardant (B) and which had no carbon dioxide dissolved therein and, hence, had not had its melt viscosity lowered), the number of discrete particles (each having a size of 50 μm or more) dispersed in the shaped article was more than 100/mm² (specifically 150/mm²), and the shaped article was not satisfactory with respect to the flame retardancy, impact resistance, quality stability and appearance.

TABLE 1

| | |
|---|---|
| Example 1 | Comp. Ex. 1 |

| | | |
|---|---|---|
| Composi- | (A) PC | 100 |
| tion | (B) S1 | 10 |

| | | |
|---|---|---|
| Number (per mm²) of particles each having a | 12 | 150 |
| size of 50 μm or more | | |
| Pressure (MPa) of carbon dioxide at the vent of | 5.0 | 0 |
| the injection molding machine | | |
| Amount (% by weight) of carbon dioxide dis- | 0.40 | 0 |
| solved in the molten resin composition | | |
| Shear melt viscosity lowering ratio (%) | 12% | 0 |
| | | (reference) |
| Pressure (MPa) of the resin composition needed | 211 | 235 |
| to fill the mold cavity therewith | | |
| Flare retardancy | ⊚ | Δ |
| Izod impact strength (J/m) | 330 | 50 |
| Izod impact strength change ratio (%) | 5 | 65 |
| Appearance of the shaped article | ⊚ | Δ |

Notes: The values in the rows for “Composition” indicate the weight ratios of the components.

### EXAMPLES 2 AND 3

### Comparative Examples 2 to 4

In each of Examples 2 and 3, and Comparative Example 4, a shaped article was produced in substantially the same manner as in Example 1, except that a resin composition having a composition indicated in Table 2 was used as a raw material for producing a shaped article, and that the melt viscosity lowering ratio of the resin composition was changed by appropriately adjusting the amount of the carbon dioxide fed to the injection molding machine.

In each of Comparative Examples 2 and 3, a shaped article was produced in substantially the same manner as in Comparative Example 1, except that a resin composition having a composition indicated in Table 2 was used as a raw material for producing a shaped article.

In each of Examples 2 and 3, and Comparative Examples 2 to 4, with respect to the obtained shaped article, various measurements and evaluations were conducted by the above-mentioned methods. The results are shown in Table 2.

As apparent from Table 2, with respect to each of the shaped articles obtained in Examples 2 and 3 (each obtained by molding the molten resin composition which contained the resin component (A) and the non-halogen flame retardant (B) and which had been caused to have carbon dioxide dissolved therein, to thereby lower the melt viscosity by 10% or more), the number of discrete particles (each having a size of 50 μm or more) dispersed in the shaped article was in the range of from 0 to 100/mm², and the shaped article exhibited excellent flame retardancy, impact resistance, quality stability and appearance.

On the other hand, with respect to each of the shaped articles obtained in Comparative Examples 2 and 3 (obtained by molding the molten resin composition which contained the resin component (A) and the non-halogen flame retardant (B) and which had no carbon dioxide dissolved therein and, hence, had not had its melt viscosity lowered), the number of discrete particles (each having a size of 50 μm or more) dispersed in the shaped article was more than 100/mm², and the shaped article was not satisfactory with respect to the flame retardancy, impact resistance, quality stability and appearance.

Further, in Comparative Example 4 (in which a molten resin composition containing a halogen flame retardant instead of the non-halogen flame retardant (B) was used as a raw material for producing a shaped article), although the molten resin composition had been caused to have carbon dioxide dissolved therein to thereby lower the melt viscosity thereof, the shaped article obtained by molding the molten resin composition did not exhibit satisfactory properties. Specifically, with respect to the shaped article, the number of discrete particles (each having a size of 50 μm or more) dispersed in the shaped article was more than 100/mm², and the shaped article was not satisfactory with respect to the flame retardancy, impact resistance, quality stability and appearance.

TABLE 2

| Comp. | | | | |
|---|---|---|---|---|
| Ex | Ex. | | Comp. Ex. | |
| 2 | 2 | 3 | 3 | 4 |

| Composition | (A) PC | 100 | | |
|---|---|---|---|---|
| | (B) S1 | 5 | — | — |
| | DBD | — | 5 | 5 |

| | | | | | |
|---|---|---|---|---|---|
| Number (per mm²) of | 121 | 14 | 5 | 143 | 131 |
| particles each having a size of | | | | | |
| 50 μm or more | | | | | |
| Shear melt viscosity lowering | 0 | 10 | 30 | 0 | 10 |
| ratio (%) | (refer- | | | (refer- | |
| | ence) | | | ence) | |
| Flame retardancy | X | ◯ | ⊚ | Δ | Δ |
| Izod impact strength (J/m) | 80 | 480 | 690 | 35 | 45 |
| Izod impact strength change | 85 | 10 | 5 | 83 | 68 |
| ratio (%) | | | | | |
| Appearance of the shaped | X | ◯ | ⊚ | X | X |
| article | | | | | |

Notes: The values in the rows for “Composition” indicate the weight ratios of the components.

### EXAMPLES 4 TO 49

### Comparative Example 5

In each of Examples 4 to 49, a shaped article was produced in substantially the same manner as in Example 1, except that a resin composition having a composition indicated in Table 3 was used as a raw material for producing a shaped article.

In Comparative Example 5, a shaped article was produced in substantially the same manner as in Comparative Example 1, except that a resin composition having a composition indicated in Table 3 was used as a raw material for producing a shaped article.

In each of Examples 4 to 49, and Comparative Example 5, with respect to the obtained shaped article, various measurements and evaluations were conducted by the above-mentioned methods. The results are shown in Table 3.

As apparent from the results of Example 7 shown in Table 3, even when the melt viscosity lowering ratio of the molten resin composition (which contains the resin component (A) and the non-halogen flame retardant (B) and which has been caused to have carbon dioxide dissolved therein) used for producing a shaped article is only 9%, the number of discrete particles (each having a size of 50 μm or more) dispersed in the shaped article can be suppressed so as to be within the range of from 0 to 100/mm². Such a shaped article exhibits excellent flame retardancy, impact resistance, quality stability and appearance.

TABLE 3

| | | | | Comp. | | | | | | | |
|---|---|---|---|---|---|---|---|---|---|---|---|
| Examples | | | | Ex | Examples | | | | | | |
| 4 | 5 | 6 | 7 | 5 | 8 | 9 | 10 | 11 | 12 | 13 | 14 |

| Composition | (A) PC | 100 | | | | | |
|---|---|---|---|---|---|---|---|
| | (B) | 7 (S1) | 7 (S2) | 7 (S3) | 7 (S4) | 1 (S1) | 7 (P1) |

| | — | | | | | | | | 0.1 | 0.1 | 0.1 | |
|---|---|---|---|---|---|---|---|---|---|---|---|---|
| | | | | | | | | | (SF1) | (SF2) | (SF3) | |
| Number (per mm²) of particles | 7 | 28 | 47 | 98 | 110 | 7 | 7 | 7 | 8 | 7 | 8 | 7 |
| each having a size of 50 μm | | | | | | | | | | | | |
| or more | | | | | | | | | | | | |
| Shear melt viscosity lower- | 26 | 20 | 15 | 9 | 0 | 24 | 26 | 25 | 23 | 25 | 24 | 25 |
| ing ratio (%) | | | | | | | | | | | | |
| Flame retardancy | ⊚ | ⊚ | ◯ | ◯ | Δ | ◯ | ◯ | ◯ | ⊚ | ⊚ | ⊚ | ◯ |
| Izod impact strength (J/m) | 450 | 430 | 400 | 380 | 53 | 410 | 400 | 590 | 440 | 420 | 430 | 400 |
| Izod impact strength change | 3 | 10 | 16 | 21 | 71 | 17 | 16 | 13 | 7 | 8 | 6 | 15 |
| ratio (%) | | | | | | | | | | | | |
| Appearance of the shaped | ⊚ | ◯ | ◯ | ◯ | Δ | ◯ | ◯ | ◯ | ⊚ | ⊚ | ⊚ | ◯ |
| article | | | | | | | | | | | | |

Notes: The values in the rows for “Composition” indicate the weight ratios of the components.

| Examples | | | | | | | | | | | |
|---|---|---|---|---|---|---|---|---|---|---|---|
| 15 | 16 | 17 | 18 | 19 | 20 | 21 | 22 | 23 | 24 | 25 | 26 |

| Composition | (A) PC | | 100 |
|---|---|---|---|
| | (B) | Amount | 6 |

| | | | | | | | | | | | | |
|---|---|---|---|---|---|---|---|---|---|---|---|---|
| Type | P2 | P3 | P4 | P5 | P6 | MOH | M1 | P2/M1 = | P3/M1 = | P4/M1 = | P5/M1 = | P5/MOH = |
| | | | | | | | | 1/1 | 1/1 | 1/1 | 1/1 | 1/1 |

| | | | | | | | | | | | | |
|---|---|---|---|---|---|---|---|---|---|---|---|---|
| Number (per mm²) of particles | 11 | 13 | 12 | 10 | 15 | 13 | 12 | 10 | 9 | 11 | 12 | 13 |
| each having a size of 50 μm | | | | | | | | | | | | |
| or more | | | | | | | | | | | | |
| Shear melt viscosity lower- | 16 | 15 | 14 | 16 | 15 | 16 | 16 | 15 | 14 | 13 | 16 | 15 |
| ing ratio (%) | | | | | | | | | | | | |
| Flame retardancy | ◯ | ◯ | ⊚ | ⊚ | ⊚ | ◯ | ◯ | ⊚ | ⊚ | ⊚ | ⊚ | ⊚ |
| Izod impact strength (J/m) | 390 | 380 | 390 | 400 | 410 | 330 | 340 | 340 | 330 | 340 | 350 | 300 |
| Izod impact strength change | 18 | 17 | 15 | 15 | 15 | 14 | 14 | 16 | 14 | 13 | 18 | 14 |
| ratio (%) | | | | | | | | | | | | |
| Appearance of the shaped | ⊚ | ⊚ | ⊚ | ⊚ | ⊚ | ◯ | ◯ | ◯ | ◯ | ◯ | ◯ | ◯ |
| article | | | | | | | | | | | | |

Notes: The values in the rows for “Composition” indicate the weight ratios of the components.

| Examples | | | | | | | | | | |
|---|---|---|---|---|---|---|---|---|---|---|
| 27 | 28 | 29 | 30 | 31 | 32 | 33 | 34 | 35 | 36 | 37 |

| | | | |
|---|---|---|---|
| Composition | (A) | PC | 90 |

| Polymer | Amount | 10 | | | | | | | | | | |
|---|---|---|---|---|---|---|---|---|---|---|---|---|
| other than | Type | PA66 | PA6 | PET | PBT | EP | HIPS | ABS | SEBS | SB | PPE | PP |
| PC | | | | | | | | | | | | |

| | | |
|---|---|---|
| (B) | P3 | 10 |

| | | | | | | | | | | | |
|---|---|---|---|---|---|---|---|---|---|---|---|
| PTFE | 0 | 0.1 | 0 | 0.1 | 0.1 | 0 | 0.1 | 0.1 | 0 | 0 | 0 |

| | | | | | | | | | | | |
|---|---|---|---|---|---|---|---|---|---|---|---|
| Number (per mm²) of particles each | 11 | 13 | 12 | 15 | 11 | 12 | 12 | 13 | 10 | 11 | 10 |
| having a size of 50 μm or more | | | | | | | | | | | |
| Shear melt viscosity lowering | 31 | 28 | 32 | 29 | 33 | 28 | 27 | 29 | 29 | 30 | 29 |
| ratio (%) | | | | | | | | | | | |
| Flame retardancy | ◯ | ⊚ | ◯ | ⊚ | ⊚ | ◯ | ⊚ | ⊚ | ⊚ | ⊚ | ⊚ |
| Izod impact strength (J/m) | 150 | 140 | 410 | 400 | 380 | 90 | 80 | 420 | 80 | 380 | 420 |
| Izod impact strength change ratio (%) | 16 | 15 | 15 | 16 | 14 | 16 | 17 | 14 | 14 | 15 | 14 |
| Appearance of the shaped article | ◯ | ◯ | ◯ | ◯ | ◯ | ◯ | ◯ | ◯ | ◯ | ◯ | ◯ |

Notes: The values in the rows for “Composition” indicate the weight ratios of the components.

| Examples | | | | | | | | | | | |
|---|---|---|---|---|---|---|---|---|---|---|---|
| 38 | 39 | 40 | 41 | 42 | 43 | 44 | 45 | 46 | 47 | 48 | 49 |

| Compo- | (A) | PC | | 90 |
|---|---|---|---|---|
| sition | | Polymer | Amount | 10 |

| | | | | | | | | | | | |
|---|---|---|---|---|---|---|---|---|---|---|---|
| other | Type | EO | PVC | PPS | PMMA | PBT/PPE = | PPE/HIPS = | EP/HIPS = | EP/PPE = | TPV | PPE |
| than PC | | | | | | 1/1 | 1/1 | 1/1 | 1/1 | | |

| | | | | | |
|---|---|---|---|---|---|
| (B) | | 7 | 7 | 7 | 7 |
| | | (P6) | (S1) | (S2) | (S3) |
| | PTFE | — | 0.1 | 0.1 | 0.1 |

| | | | | | | | | | | | | |
|---|---|---|---|---|---|---|---|---|---|---|---|---|
| Number (per mm²) of particles | 12 | 13 | 13 | 12 | 13 | 15 | 11 | 12 | 12 | 13 | 14 | 15 |
| each having a size of 50 μm | | | | | | | | | | | | |
| or more | | | | | | | | | | | | |
| Shear melt viscosity lowering | 28 | 27 | 28 | 29 | 30 | 30 | 31 | 28 | 27 | 29 | 30 | 30 |
| ratio (%) | | | | | | | | | | | | |
| Flame retardancy | ◯ | ◯ | ◯ | ◯ | ◯ | ◯ | ◯ | ⊚ | ⊚ | ⊚ | ⊚ | ⊚ |
| Izod impact strength (J/m) | 120 | 450 | 410 | 230 | 320 | 460 | 100 | 250 | 350 | 440 | 220 | 260 |
| Izod impact strength change | 16 | 16 | 14 | 17 | 16 | 15 | 16 | 17 | 15 | 13 | 15 | 13 |
| ratio (%) | | | | | | | | | | | | |
| Appearance of the shaped article | ◯ | ◯ | ◯ | ◯ | ◯ | ◯ | ◯ | ◯ | ◯ | ◯ | ◯ | ◯ |

Notes: The values in the rows for “Composition” indicate the weight ratios of the components.

### Industrial Applicability

The shaped article of the present invention exhibits not only an excellent flame retardancy, but also excellent appearance, impact resistance and stability in quality (e.g., ability to suppress lowering of Izod impact strength of the shaped article, which occurs during a continuous molding of the above-mentioned molten resin composition), so that the shaped article of the present invention can be advantageously used as, for example: housings, chassis or parts for household electric appliances, such as a VTR, a distribution switchboard, a television set, an audio player, a capacitor, a plug socket for domestic use, a radio cassette recorder, a video cassette, a video disk player, an air conditioner, a humidifier and an electric hot-air supplier; a main frame for a CD-ROM drive; housings, chassis or parts for office automation machines, such as a printer, a fax machine, a CRT, a word processor, a copying machine (such as a PPC), an electronic cash register, an office computer system, a floppy disk drive, a keyboard, a typewriter, an electric calculator, a toner cartridge and a telephone; electronic or electric materials, such as a connector, a coil bobbin, a switch, relay, a relay socket, an LED, a variable capacitor, an AC adapter, an FBT high-voltage bobbin, an FBT case, an IFT coil bobbin, a jack, a volume shaft and a motor part; and automobile parts, such as an instrument panel, a radiator grille, a cluster, a speaker grille, a louver, a console box, a defroster garnish, an ornament, a fuse box, a relay case and a connector shift tape.

1. A shaped article obtained by (1) melting a flame retardant polycarbonate resin composition comprising a resin component (A) consisting of an aromatic polycarbonate or mainly comprising an aromatic polycarbonate, and a non-halogen flame retardant (B), and (2) molding the resultant molten resin composition, wherein the number of discrete particles, dispersed in said shaped article, each having a size of 50 μm or more, is 0 to 100/mm² as measured with respect to the surface of a flat sample cut out from said shaped article.

2. The shaped article according to claim 1, wherein the molten flame retardant polycarbonate resin composition which is being molded has carbon dioxide dissolved therein, so that said molten resin composition having carbon dioxide dissolved therein exhibits a shear melt viscosity which is lower than the shear melt viscosity exhibited by the resin composition having no carbon dioxide dissolved therein.

3. The shaped article according to claim 2, wherein said molten resin composition having carbon dioxide dissolved therein exhibits a shear melt viscosity which is lowered by 10% or more, relative to the shear melt viscosity exhibited by the resin composition having no carbon dioxide dissolved therein.

4. The shaped article according to claim 2 or 3, wherein said molten resin composition having carbon dioxide dissolved therein is subjected to injection molding, wherein said molten resin composition having carbon dioxide dissolved therein is injected into a mold cavity which has been pressurized by carbon dioxide gas to a pressure level wherein no foaming occurs at a flow front of said molten resin composition in said cavity.

5. The shaped article according to any one of claims 1 to 4, wherein said non-halogen flame retardant is at least one flame retardant selected from the group consisting of an organic flame retardant and an inorganic flame retardant.

6. The shaped article according to claim 5, wherein said organic flame retardant is at least one flame retardant selected from the group consisting of a silicon-containing flame retardant, a sulfur-containing flame retardant and a phosphorus-containing flame retardant.

7. The shaped article according to claim 6, wherein said silicon-containing flame retardant is a polyorganosiloxane comprising at least one unit selected from the group consisting of an M unit represented by formula R₃SiO_{0.5}; a D unit represented by formula R₂SiO_{1.0}; a T unit represented by formula RSiO_{1.5}; and a Q unit represented by formula SiO_{2.0}, wherein each R independently represents a hydrocarbon group having 1 to 20 carbon atoms.

8. The shaped article according to any one of claims 1 to 7, which is pellets.

9. The shaped article according to any one of claims 1 to 7, which is a utility article.
